(19) United States
(12) Patent Application Publication
(10) Pub. No.: US 2016/0231615 A1
(43) Pub. Date: Aug. 11, 2016

(54) PHOTOSENSITIVE RESIN COMPOSITION AND A DISPLAY PANEL INCLUDING THE SAME

(71) Applicant: SAMSUNG DISPLAY CO., LTD., Yongin-City (KR)

(72) Inventors: Min-Ki NAM, Gyeonggi-do (KR); Hae-II PARK, Seoul (KR); Seon-Tae YOON, Seoul (KR); Kwang-Keun LEE, Gyeonggi-do (KR)

(21) Appl. No.: 14/816,449

(22) Filed: Aug. 3, 2015

(30) Foreign Application Priority Data
Feb. 6, 2015 (KR) 10-2015-0018861

(51) Int. Cl. G02F 1/1335; C09K 11/88; C09K 11/89; C09K 11/62; C09K 11/64; C09K 11/02; C09K 11/70

(52) U.S. Cl. CPC G02F 1/133512; C09K 11/025; C09K 11/881; C09K 11/701; C09K 11/621; C09K 11/641; C09K 11/892

(57) ABSTRACT

A photosensitive resin composition includes about 60% by weight to about 95% by weight of a solvent based on a total weight of the photosensitive resin composition and about 5% by weight to about 40% by weight of a solid based on the total weight of the photosensitive resin composition. The solid includes about 5% by weight to about 90% by weight of quantum dots based on a total weight of the solid. A center luminescence wavelength of the quantum dots is about 900 nm to about 2000 nm.

### CROSS-REFERENCE TO RELATED APPLICATION

This application claims priority under 35 U.S.C. §119 to Korean Patent Application No. 10-2015-0018861, filed on Feb. 6, 2015, the disclosure of which is incorporated by reference herein in its entirety.

### TECHNICAL FIELD

Exemplary embodiments of the inventive concept relate to a photosensitive resin composition and a display panel, and more particularly, to a photosensitive resin composition and a display panel for emitting an infrared ray.

### DISCUSSION OF THE RELATED ART

A liquid crystal display apparatus applies a voltage to a liquid crystal layer to change arrangement of the liquid crystal layer. By adjusting the liquid crystal layer optical properties such as birefringence, rotary polarization, dichroism, or light scattering may be changed to display an image.

A display panel may include a thin film transistor substrate, a color filter substrate opposite to the thin film transistor substrate and a liquid crystal layer disposed between the thin film transistor substrate and the color filter substrate.

The thin film transistor substrate may include gate lines, data lines crossing the gate lines, thin film transistors connected to the gate lines and the data lines and a pixel electrode for independent driving of a plurality of pixels. The color filter substrate may include a color filter layer having a red (R) color filter, a green (G) color filter and a blue (B) color filter, a common electrode opposite to the pixel electrode and a black matrix disposed on boundaries of the color filters. The black matrix may be used to block light.

### SUMMARY

An exemplary embodiment of the inventive concept provides a photosensitive resin composition for emitting an infrared ray.

An exemplary embodiment of the inventive concept provides a display panel having the photosensitive resin composition.

According to an exemplary embodiment of the inventive concept, a photosensitive resin composition includes about 60% by weight to about 95% by weight of a solvent based on a total weight of the photosensitive resin composition and about 5% by weight to about 40% by weight of a solid based on the total weight of the photosensitive resin composition. The solid includes about 5% by weight to about 90% by weight of quantum dots based on a total weight of the solid. A center luminescence wavelength of the quantum dots is about 900 nm to about 2000 nm.

In an exemplary embodiment of the inventive concept, the solid may include about 4% by weight to about 70% by weight of a photo polymerization compound based on the total weight of the solid, about 0.1% by weight to about 20% by weight of a photo polymerization initiator based on the total weight of the solid, about 5% by weight to about 80% by weight of an alkali-soluble resin based on the total weight of the solid and about 0.1% by weight to about 12% by weight of a dispersing agent based on the total weight of the solid.

In an exemplary embodiment of the inventive concept, at least one of the quantum dots may include a core and a shell surrounding the core.

In an exemplary embodiment of the inventive concept, the core may include lead selenide (PbSe), lead sulfide (PbS), lead telluride (PbTe) or copper oxide (CuO).

In an exemplary embodiment of the inventive concept, the shell may include indium phosphide (InP), indium nitride (InN), gallium phosphide (GaP), gallium nitride (GaN), aluminum nitride (AlN), aluminum phosphide (AlP), aluminum arsenide (AlAs), cadmium sulfide (CdS), cadmium selenide (CdSe), cadmium telluride (CdTe), zinc telluride (ZnTe), zinc sulfide (ZnS), zinc selenide (ZnSe), mercury sulfide (HgS), mercury selenide (HgSe) or mercury telluride (HgTe).

In an exemplary embodiment of the inventive concept, a diameter of the core and a diameter of the shell may be about 2 nm to about 20 nm, respectively.

In an exemplary embodiment of the inventive concept, the solid may further include a coloring agent, an amount of the coloring agent may be about 0.1% by weight to about 5% by weight based on the total weight of the solid.

In an exemplary embodiment of the inventive concept, the coloring agent may include carbon black, urea resin, melamine resin, phenol resin or epoxy resin.

In an exemplary embodiment of the inventive concept, the alkali-soluble resin may include a monocarboxylic acid compound, a dicarboxylic acid compound, a mono methacrylate compound, an alkyl ester compound, a carboxylic ester compound, a vinyl compound, an alicyclic compound having an unsaturated bond with an epoxy group, an epoxy compound or dicarbonyl imide derivatives.

In an exemplary embodiment of the inventive concept, the dispersing agent may include a polyoxyethylene alkyl ether compound, a polyoxyethylene alkyl phenyl ether compound, a polyethylene glycol diester compound, a sorbitan fatty acid ester compound, a fatty acid-modified polyester compound, a tertiary amine modified polyurethane compound, an alkyl ammonium compound or a polyethyleneimine compound.

According to an exemplary embodiment of the inventive concept, a display panel includes a first substrate including a black matrix including quantum dots, a second substrate opposite to the first substrate and a liquid crystal layer disposed between the first substrate and the second substrate. A center luminescence wavelength of the quantum dots is about 900 nm to about 2000 nm.

In an exemplary embodiment of the inventive concept, the black matrix may include about 60% by weight to about 95% by weight of a solvent based on a total weight of a photosensitive resin composition and about 5% by weight to about 40% by weight of a solid based on the total weight of the photosensitive resin composition. The solid may include about 5% by weight to about 20% by weight of the quantum dots based on a total weight of the solid, about 4% by weight to about 70% by weight of a photo polymerization compound based on the total weight of the solid, about 0.1% by weight to about 20% by weight of a photo polymerization initiator based on the total weight of the solid, about 5% by weight to about 80% by weight of an alkali-soluble resin based on the total weight of the solid and about 0.1% by weight to about 12% by weight of a dispersing agent based on the total weight of the solid.

In an exemplary embodiment of the inventive concept, at least one of the quantum dots may include a core and a shell surrounding the core.

In an exemplary embodiment of the inventive concept, the core may include lead selenide (PbSe), lead sulfide (PbS), lead telluride (PbTe) or copper oxide (CuO).

In an exemplary embodiment of the inventive concept, the shell may include indium phosphide (InP), indium nitride (InN), gallium phosphide (GaP), gallium nitride (GaN), aluminum nitride (AlN), aluminum phosphide (AlP), aluminum arsenide (AlAs), cadmium sulfide (CdS), cadmium selenide (CdSe), cadmium telluride (CdTe), zinc telluride (ZnTe), zinc sulfide (ZnS), zinc selenide (ZnSe), mercury sulfide (HgS), mercury selenide (HgSe) or mercury telluride (HgTe).

In an exemplary embodiment of the inventive concept, a diameter of the core and a diameter of the shell may be about 2 nm to about 20 nm, respectively.

In an exemplary embodiment of the inventive concept, the solid may further include a coloring agent. An amount of the coloring agent may be about 0.1% by weight to about 5% by weight based on the total weight of the solid.

In an exemplary embodiment of the inventive concept, the coloring agent may include carbon black, urea resin, melamine resin, phenol resin or epoxy resin.

In an exemplary embodiment of the inventive concept, the alkali-soluble resin may include a monocarboxylic acid compound, a dicarboxylic acid compound, a mono methacrylate compound, an alkyl ester compound, a carboxylic ester compound, a vinyl compound, an alicyclic compound having an unsaturated bond with an epoxy group, an epoxy compound or dicarbonyl imide derivatives.

In an exemplary embodiment of the inventive concept, the dispersing agent may include a polyoxyethylene alkyl ether compound, a polyoxyethylene alkyl phenyl ether compound, a polyethylene glycol diester compound, a sorbitan fatty acid ester compound, a fatty acid-modified polyester compound, a tertiary amine modified polyurethane compound, an alkyl ammonium compound or a polyethyleneimine compound.

According to an exemplary embodiment of the inventive concept, a display panel includes a first substrate, a second substrate opposite to the first substrate, a liquid crystal layer disposed between the first substrate and the second substrate and a black matrix disposed on the first substrate or the second substrate. The black matrix includes a plurality of quantum dots. A center luminescence wavelength of the quantum dots is about 900 nm to about 2000 nm.

In an exemplary embodiment of the inventive concept, the black matrix may include about 60% by weight to about 95% by weight of a solvent based on a total weight of a photosensitive resin composition and about 5% by weight to about 40% by weight of a solid based on the total weight of the photosensitive resin composition. The solid comprises about 5% by weight to about 90% by weight of the quantum dots based on a total weight of the solid.

In an exemplary embodiment of the inventive concept, the solid may include about 4% by weight to about 70% by weight of a photo polymerization compound based on the total weight of the solid, about 0.1% by weight to about 20% by weight of a photo polymerization initiator based on the total weight of the solid, about 5% by weight to about 80% by weight of an alkali-soluble resin based on the total weight of the solid and about 0.1% by weight to about 12% by weight of a dispersing agent based on the total weight of the solid.

### BRIEF DESCRIPTION OF THE DRAWINGS

The above and other features of the inventive concept will become more apparent by describing in detail exemplary embodiments thereof with reference to the accompanying drawings, in which:

FIG. 1 is a cross-sectional view illustrating a display panel in accordance with an exemplary embodiment of the inventive concept;

FIG. 2 is a cross-sectional view illustrating a display panel in accordance with an exemplary embodiment of the inventive concept;

FIG. 3 is a cross-sectional view illustrating a display panel in accordance with an exemplary embodiment of the inventive concept; and

FIG. 4 is a cross-sectional view illustrating a display panel in accordance with an exemplary embodiment of the inventive concept.

### DETAILED DESCRIPTION OF THE EMBODIMENTS

Hereinafter, exemplary embodiments of the inventive concept will be explained in detail with reference to the accompanying drawings.

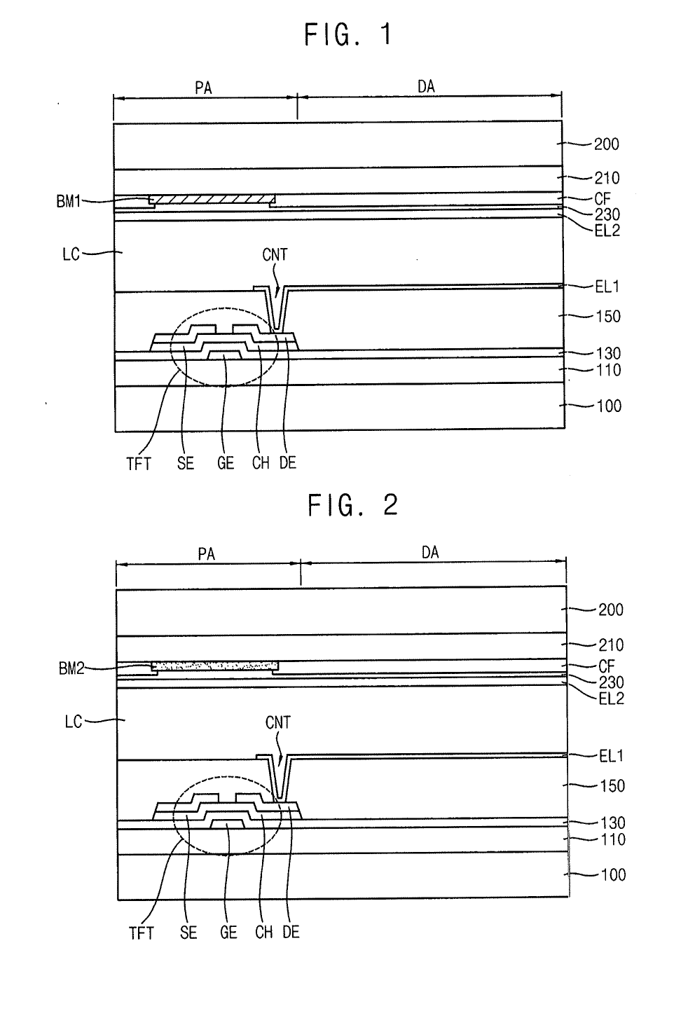

FIG. 1 is a cross-sectional view illustrating a display panel in accordance with an exemplary embodiment of the inventive concept.

Referring to FIG. 1, a display panel includes an array substrate, a opposing substrate and a liquid crystal layer LC disposed between the array substrate and the opposing substrate. The display panel includes a display area DA and a peripheral area PA. The display area DA is an area where images are produced and displayed. For example, light transmitted from a backlight unit is used to display an image in the display area DA. The peripheral area PA is an area where the images are blocked.

The array substrate includes a first polarizing plate 100, a first substrate 110, a gate insulation layer 130, a thin film transistor TFT, a protecting layer 150 and a first electrode EL1.

The first polarizing plate 100 is contacted with a lower surface of the first substrate 110. The first polarizing plate 100 controls polarization of light incident to the liquid crystal layer LC. The first polarizing plate 100 may include a compensation film having an anisotropic refractive index and including a triacetyl cellulose film, a cyclo olefin polymer or a polymethyl methacrylate, a polarization film including polyvinyl alcohol and a base film supporting the polarization film.

The first substrate 110 may include a material which has a relatively high transmittance, thermo stability and chemical compatibility. For example, the first substrate may include glass, polyethylene naphthalate, polyethylene terephthalate or polyacryl.

A gate electrode GE and a gate line are disposed on the first substrate 110.

The gate insulation layer 130 is disposed on the first substrate 110, the gate electrode GE and the gate line. The gate insulation layer 130 may include an inorganic material such as silicon oxide (SiOx) or silicon nitride (SiNx), but is not limited thereto.

A channel layer CH is disposed on the first insulation layer 130 to overlap the gate electrode GE. For example, the channel layer CH may include a semiconductor layer of amorphous silicon (a-Si:H) and an ohmic contact layer of, for example, n+ amorphous silicon (n+ a-Si:H). In addition, the channel layer CH may include an oxide semiconductor. For example, the oxide semiconductor may include an amorphous oxide including indium (In), zinc (Zn), gallium (Ga), tin (Sn) or hafnium (Hf). For example, the oxide semiconductor may include an amorphous oxide having indium (In), zinc (Zn) and gallium (Ga), or an amorphous oxide having indium (In), zinc (Zn) and hafnium (Hf). For example, the oxide semiconductor may include an oxide such as indium zinc oxide (InZnO), indium gallium oxide (InGaO), indium tin oxide (InSnO), zinc tin oxide (ZnSnO), gallium tin oxide (GaSnO) or gallium zinc oxide (GaZnO).

A source electrode SE and a drain electrode DE are disposed on the channel layer CH. The source electrode SE is electrically connected to a data line, and spaced apart from the drain electrode DE. The drain electrode DE is electrically connected to the first electrode EL1 through a contact hole CNT.

The gate electrode GE, the source electrode SE, the drain electrode DE and the channel layer CH form the thin film transistor TFT.

The protecting layer 150 is disposed on the thin film transistor TFT. The protecting layer 150 may include an inorganic material such as silicon oxide (SiOx) or silicon nitride (SiNx). In addition, the protecting layer 150 may include an organic insulating material having a relatively low permittivity. The protecting layer 150 may be formed as a multi-layer including the inorganic insulation layer and the organic insulation layer. In addition, the protecting layer 150 may include the contact hole CNT to expose a portion of the drain electrode DE.

The opposing substrate includes a second polarizing plate 200, a second substrate 210, a black matrix BM1, a color filter CF, a over-coating layer 230 and a second electrode EL2.

The second polarizing plate 200 is contacted with a upper surface of the second substrate 210. The second polarizing plate 200 controls polarization of light incident to the liquid crystal layer LC. The second polarizing plate 200 may include a compensation film having an anisotropic refractive index and including a triacetyl cellulose film, a cyclo olefin polymer or a polymethyl methacrylate, a polarization film including polyvinyl alcohol and a base film supporting the polarization film.

The second substrate 210 is opposite to the first substrate 110.

The second substrate 210 may include a material which has a relatively high transmittance, thermo stability and chemical compatibility. For example, the second substrate 210 may include glass, polyethylene naphthalate, polyethylene terephthalate or polyacryl.

The black matrix BM1 is disposed on a lower surface of the second substrate 210. The black matrix BM1 corresponds to the peripheral area PA and blocks the light. The black matrix BM1 overlaps the data line, the gate line and the thin film transistor TFT.

The black matrix BM1 is formed based on a photosensitive resin composition. The photosensitive resin composition includes about 60% by weight to about 95% by weight of a solvent based on a total weight of the photosensitive resin composition and about 5% by weight to about 40% by weight of a solid based on the total weight of the photosensitive resin composition.

For example, the solvent may include a monoalcohol such as methanol, ethanol, n-propanol, isopropanol, ethylene glycol or propylene glycol, a terpene such as α-terpineol or β-terpineol, a ketone such as acetone, methylethylketone, cyclohexanone or N-methyl-2-pyrrolidone, aromatic hydrocarbons such as toluene, xylene or tetramethylbenzene, a glycol ether such as cellosolve, methylcellosolve, ethylcellosolve, carbitol, methylcarbitol, ethylcarbitol, butylcarbitol, propylene glycol monomethyl ether, propylene glycol monoethyl ether, dipropylene glycol monomethyl ether, dipropylene glycol monoethyl ether, tripropylene glycol monomethyl ether or tripropylene glycol monoethyl ether, an acetic acid ester such as ethyl acetate, methyl acetate, cellosolve acetate, ethyl cellosolve acetate, butyl cellosolve acetate, carbitol acetate, ethyl carbitol acetate, butyl carbitol acetate, propylene glycol monomethyl ether acetate or propylene glycol monoethyl ether acetate. These can be used alone or in combination.

The solid includes a photo polymerization compound, a photo polymerization initiator, an alkali-soluble resin, quantum dots and a dispersing agent.

An amount of the photo polymerization compound is about 4% by weight to about 70% by weight based on the total weight of the solid. The photo polymerization compound includes a double bond and reacts a radical formed based on the photo polymerization initiator. The photo polymerization compound forms cross-linked bond with other photo polymerization monomer or binder resin.

For example, the photo polymerization compound may include acrylate groups. For example, the photo polymerization compound may include a multi-functional monomer and a mono-functional monomer according to the acrylate groups.

For example, the multi-functional monomer may include a dipentaerythritol hexaacrylate, a pentaerythritol triacrylate, a pentaerythritol tetraacrylate, a trimethylpropane triacrylate, a trimethylpropane trimethacrylate, a glycerol triacrylate, a tris(2-hydroxyethyl)isocyanurate triacrylate, a di-trimethylpropane tetraacrylate, a dipentaerythritol pentaacrylate, a pentaerythritol tetraacrylate, etc. These can be used alone or in combination.

For example, the mono-functional monomer may include a glycidyl methacrylate, a hydroxyethyl methacrylate, a 2-hydroxy-3-phenoxypropyl acrylate, a diethyleneglycol methylether methacrylate, a hydroxyethyl acrylate, a butyl methacrylate, a hydroxypropyl acrylate, a 2-phenoxyethyl acrylate, a 2-pheonoxyethyl methacrylate, a 3,3,5-trimethylcyclohexyl methacrylate, an isobornyl acrylate, an isobornyl methacrylate, an isodecyl acrylate, an isodecyl methacrylate, an isooctyl acrylate, a lauryl acrylate, a stearyl acrylate, a tetrahydrofurfuryl acrylate, a tridecyl acrylate, etc. These can be used alone or in combination.

For example, the photo polymerization compound is represented by following Chemical Formula 1.

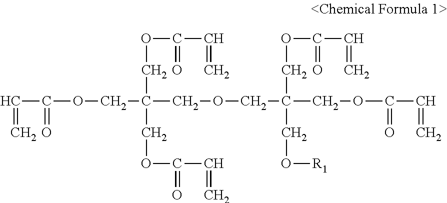

R1 is Hydrogen or an acryloyl group having carbon number of 2 to 6.

An amount of the photo polymerization initiator is about 0.1% by weight to about 20% by weightbased on the total weight of the solid. A radical is generated by emitting light on the photo polymerization initiator, and the photosensitive resin composition may be photo-cured based on the radical.

For example, the photo polymerization initiator may include an acetophenone compound, a biimidazole compound, a triazine compound, an onium salt compound, a benzoin compound, a benzophenone compound, a diketone compound, a α-diketone compound, a multinuclear quinone, a thiozanthone compound, a diazo compound, an imide-sulfonate compound, an oxime compound, a carbazole compound, a sulfonium borate compound or a combination thereof.

The alkali-soluble resin is about 5% by weight to about 80% by weight based on a total weight of the solid. The alkali-soluble resin may be dissolved with the solvent and may have a reactivity based on its optical properties or thermal properties. The alkali-soluble resin may function as a binder resin with respect to the quantum dot and may be dissolved with an alkali developer.

For example, the alkali-soluble resin may include a monocarboxylic acid compound, a dicarboxylic acid compound, a mono methacrylate compound, an alkyl ester compound, a carboxylic ester compound, a vinyl compound, an alicyclic compound having an unsaturated bond with an epoxy group, an epoxy compound or dicarbonyl imide derivatives.

An amount of the quantum dots is about 5% by weight to about 90% by weight based on a total weight of the solid.

At least one of the quantum dots may include a core and a shell surrounding the core.

An individual quantum dot is a semiconductor crystal where a quantum is injected. When an electric current is applied to the injected quantum, the quantum emits light by itself. The quantum dot may absorb the visible light and may emit the infrared ray. Thus, the photosensitive resin composition may absorb the visible light and may represent a black color.

A center luminescence wavelength of the quantum dots is about 900 nm to about 2000 nm.

For example, the core may include lead selenide (PbSe), lead sulfide (PbS), lead telluride (PbTe) or copper oxide (CuO).

For example, the shell may include indium phosphide (InP), indium nitride (InN), gallium phosphide (GaP), gallium nitride (GaN), aluminum nitride (AlN), aluminum phosphide (AlP), aluminum arsenide (AlAs), cadmium sulfide (CdS), cadmium selenide (CdSe), cadmium telluride (CdTe), zinc telluride (ZnTe), zinc sulfide (ZnS), zinc selenide (ZnSe), mercury sulfide (HgS), mercury selenide (HgSe) or mercury telluride (HgTe).

A diameter of the core and a diameter of the shell are about 2 nm to about 20 nm, respectively.

An amount of the dispersing agent is about 0.1% by weight to about 12% by weight based on the total weight of the solid.

For example, the dispersing agent may include a polyoxyethylene alkyl ether compound, a polyoxyethylene alkyl phenyl ether compound, a polyethylene glycol diester compound, a sorbitan fatty acid ester compound, a fatty acid-modified polyester compound, a tertiary amine modified polyurethane compound, an alkyl ammonium compound or a polyethyleneimine compound.

For example, the black matrix BM1 including the quantum dots emits the infrared ray having a wavelength of about 0.75 μm to about 1 mm and absorbs the visible light having a wavelength of about 380 nm to about 800 nm. Thus, the black matrix BM1 may block energy above a mobility gap of the thin film transistor TFT.

A conventional black matrix may only block visible light. However, the black matrix BM1 in accordance with an exemplary embodiment of the inventive concept may emit the infrared ray and may absorb the visible light.

According to an exemplary embodiment of the inventive concept, the black matrix BM1 including the quantum dots may emit the infrared ray. Thus, the display panel may be employed in apparatuses which use the infrared ray to improve health and beauty effects of a person, for example.

The color filter CF is disposed on the black matrix BM1 and the second substrate 210. The color filter CF colors the light passing through the liquid crystal layer LC. The color filter CF may include a red color filter, a green color filter and a blue color filter, but is not limited thereto. The color filter CF corresponds to a pixel area. The display panel may include a plurality of color filters. Color filters adjacent to each other may have different colors from each other, but are not limited thereto. For example, the color filter CF may overlap an adjacent color filter in a boundary of the pixel area. For another example, the color filter CF may be spaced apart from an adjacent color filter in the boundary of the pixel area.

The over-coating layer 230 is disposed on the color filter CF and the black matrix BM1. The over-coating layer 230 protects and insulates the color filter CF, and provides a substantially planar surface to flatten the stepped profile of the color filter CF. The over-coating layer 230 may include an acrylic-epoxy material, but is not limited thereto.

The second electrode EL2 corresponds to the pixel area. The second electrode EL2 is electrically connected to a common voltage line. The second electrode EL2 may have a slit pattern including a plurality of openings. The second electrode EL2 may include a transparent conductive material such as indium tin oxide (ITO), indium zinc oxide (IZO), etc.

The liquid crystal layer LC is disposed between the array substrate and the opposing substrate. The liquid crystal layer LC includes liquid crystal molecules having optical anisotropy. The liquid crystal molecules are driven by an electric field generated by voltages applied to the first electrode EL1 and the second electrode EL2 such that an image is displayed by passing or blocking light through the liquid crystal layer LC.

FIG. 2 is a cross-sectional view illustrating a display panel in accordance with an exemplary embodiment of the inventive concept.

Referring to FIG. 2, the elements in the display panel of FIG. 2 may be substantially the same as the elements in the display panel of FIG. 1, except for the black matrix BM1. Thus, any further descriptions concerning the same elements may be omitted.

A black matrix BM2 is disposed on a lower surface of a second substrate 210. The black matrix BM2 corresponds to the peripheral area PA and blocks the light. The black matrix BM2 overlaps the data line, the gate line and the thin film transistor TFT.

The black matrix BM2 is formed based on a photosensitive resin composition. The photosensitive resin composition includes about 60% by weight to about 95% by weight of a solvent based on a total weight of the photosensitive resin composition and about 5% by weight to about 40% by weight of a solid based on the total weight of the photosensitive resin composition.

The solid includes a photo polymerization compound, a photo polymerization initiator, an alkali-soluble resin, quantum dots, a dispersing agent and a coloring agent.

The elements in the photosensitive resin composition may be substantially the same as the elements in the photosensitive resin composition of FIG. 1, except for the coloring agent. Thus, any further descriptions concerning the same elements may be omitted.

An amount of the coloring agent is about 0.1% by weight to about 5% by weight based on a total weight of the solid. The coloring agent of the black matrix BM2 may absorb the visible light.

For example, the coloring agent may include a color (Red, Green, or Blue) mixing pigment, an organic color agent or an inorganic coloring agent such as carbon black, etc. Thus, the photosensitive resin composition represents a black color. The coloring agent may include organic materials. For example, the organic materials may include a thermosetting resin or a photo curable resin. For example, the thermosetting resin may include urea resin, melamine resin, phenol resin, etc. For example, the photo curable resin may include polymerizable compounds having a polymerizable functional group, a photo polymerization initiator initiating polymerization of the polymerizable compounds by irradiation, surfactants, antioxidants, etc.

For example, the black matrix BM2 including the quantum dots and the coloring agent emits the infrared ray having a wavelength of about 0.75 μm to about 1 mm and absorbs the visible light having a wavelength of about 380 nm to about 800 nm. Thus, the black matrix BM2 may block energy above a mobility gap of the thin film transistor TFT.

A center luminescence wavelength of the quantum dots is about 900 nm to about 2000 nm.

A conventional black matrix may only block visible light. However, the black matrix BM2 in accordance with an exemplary embodiment of the inventive concept may emit the infrared ray and may absorb the visible light.

According to an exemplary embodiment of the inventive concept, the black matrix BM2 including the quantum dots may emit the infrared ray. Thus, the display panel may be employed in apparatuses which use the infrared ray to improve health and beauty effects of a person, for example.

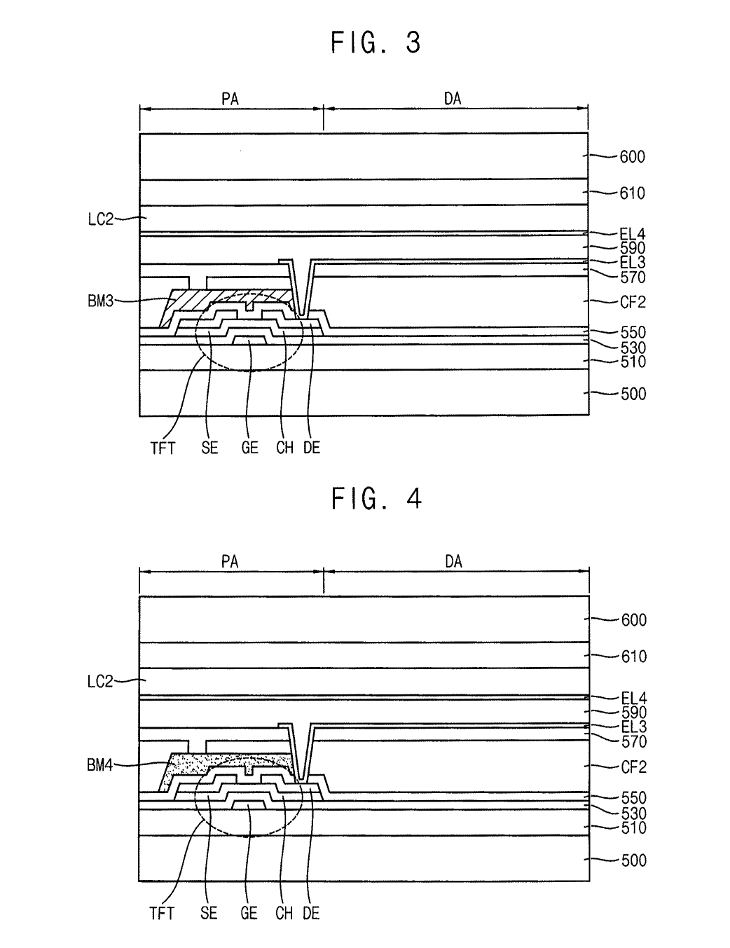

FIG. 3 is a cross-sectional view illustrating a display panel in accordance with an exemplary embodiment of the inventive concept.

Referring to FIG. 3, a display panel includes an array substrate, an opposing substrate and a liquid crystal layer LC2 disposed between the array substrate and the opposing substrate. The display panel includes a display area DA and a peripheral area PA. The display area DA is an area where images are produced and displayed. For example, light transmitted from a backlight unit is used to display an image in the display area DA. The peripheral area PA is an area where the images are blocked.

The array substrate includes a first polarizing plate 500, a first substrate 510, a gate insulation layer 530, a thin film transistor TFT, a protecting layer 550, a black matrix BM3, a color filter CF2, a over-coating layer 570, a first electrode EL3, a protecting layer 590 and a second electrode EL4.

The first polarizing plate 500 is contacted with a lower surface of the first substrate 510. The first polarizing plate 500 controls polarization of light incident to the liquid crystal layer LC2. The first polarizing plate 500 may include a compensation film having an anisotropic refractive index and including a triacetyl cellulose film, a cyclo olefin polymer or a polymethyl methacrylate, a polarization film including polyvinyl alcohol and a base film supporting the polarization film.

The first substrate 510 includes a material which has a relatively high transmittance, thermo stability and chemical compatibility. For example, the first substrate may include glass, polyethylene naphthalate, polyethylene terephthalate or polyacryl.

A gate electrode GE and a gate line are disposed on the first substrate 510.

The gate insulation layer 530 is disposed on the first substrate 510, the gate electrode GE and the gate line. The gate insulation layer 530 may include an inorganic material such as silicon oxide (SiOx) or silicon nitride (SiNx), but is not limited thereto.

A channel layer CH is disposed on the first insulation layer 530 to overlap the gate electrode GE. For example, the channel layer CH may include a semiconductor layer of amorphous silicon (a-Si:H) and an ohmic contact layer of, for example, n+ amorphous silicon (n+ a-Si:H). In addition, the channel layer CH may include an oxide semiconductor. For example, the oxide semiconductor may include an amorphous oxide including indium (In), zinc (Zn), gallium (Ga), tin (Sn) or hafnium (Hf). For example, the oxide semiconductor may include an amorphous oxide having indium (In), zinc (Zn) and gallium (Ga), or an amorphous oxide having indium (In), zinc (Zn) and hafnium (Hf). For example, the oxide semiconductor may include an oxide such as indium zinc oxide (InZnO), indium gallium oxide (InGaO), indium tin oxide (InSnO), zinc tin oxide (ZnSnO), gallium tin oxide (GaSnO) or gallium zinc oxide (GaZnO).

A source electrode SE and a drain electrode DE are disposed on the channel layer CH. The source electrode SE is electrically connected to a data line, and spaced apart from the drain electrode DE. The drain electrode DE is electrically connected to the first electrode EL3 through a contact hole CNT.

The gate electrode GE, the source electrode SE, the drain electrode DE and the channel layer CH form the thin film transistor TFT.

The protecting layer 550 is disposed on the thin film transistor TFT. The protecting layer 550 may include an inorganic material such as silicon oxide (SiOx) or silicon nitride (SiNx). In addition, the protecting layer 550 may include an organic insulating material having a relatively low permittivity. The protecting layer 550 may be formed as a multi-layer including the inorganic insulation layer and the organic insulation layer. In addition, the protecting layer 550 may include the contact hole CNT to expose a portion of the drain electrode DE.

The black matrix BM3 is disposed on the protecting layer 550. The black matrix BM3 corresponds to the peripheral area PA and blocks the light. The black matrix BM3 overlaps the data line, the gate line and the thin film transistor TFT.

The black matrix BM3 is formed based on a photosensitive resin composition. The photosensitive resin composition includes about 60% by weight to about 95% by weight of a solvent based on a total weight of the photosensitive resin composition and about 5% by weight to about 40% by weight of a solid based on the total weight of the photosensitive resin composition.

The solid includes a photo polymerization compound, a photo polymerization initiator, an alkali-soluble resin, quantum dots and a dispersing agent.

The elements in the photosensitive resin composition may be substantially the same as the elements in the photosensitive resin composition of FIG. 1. Thus, any further descriptions concerning the same elements may be omitted.

For example, the black matrix BM3 including the quantum dots emits the infrared ray having a wavelength of about 0.75 μm to about 1 mm and absorbs the visible light having a wavelength of about 380 nm to about 800 nm. Thus, the black matrix BM3 may block energy above a mobility gap of the thin film transistor TFT.

A center luminescence wavelength of the quantum dots is about 900 nm to about 2000 nm.

A conventional black matrix may only block visible light. However, the black matrix BM3 in accordance with an exemplary embodiment of the inventive concept may emit the infrared ray and may absorb the visible light.

According to an exemplary embodiment of the inventive concept, the black matrix BM3 including the quantum dots may emit the infrared ray. Thus, the display panel may be employed in apparatuses which use the infrared ray to improve health and beauty effects of a person, for example.

The color filter CF2 is disposed on the black matrix BM3 and the protecting layer 550. The color filter CF2 colors the light passing through the liquid crystal layer LC2. The color filter CF2 may include a red color filter, a green color filter and a blue color filter, but is not limited thereto. The color filter CF2 corresponds to a pixel area. The display panel may include a plurality of color filters. Color filters adjacent to each other may have different colors from each other, but are not limited thereto. For example, the color filter CF2 may overlap an adjacent color filter in a boundary of the pixel area. For another example, the color filter CF2 may be spaced apart from an adjacent color filter in the boundary of the pixel area.

The over-coating layer 570 is disposed on the color filter CF2 and the black matrix BM3. The over-coating layer 570 protects and insulates the color filter CF, and provides a substantially planar surface to flatten the stepped profile of the color filter CF2. The over-coating layer 570 may include an acrylic-epoxy material, but is not limited thereto. The over-coating layer 570 may include the contact hole CNT to expose a portion of the drain electrode DE.

The first electrode EL3 is disposed on the over-coating layer 570. The first electrode EL3 may have a slit pattern including a plurality of openings. The first electrode EL3 may include a transparent conductive material such as indium tin oxide (ITO), indium zinc oxide (IZO), etc.

The protecting layer 590 is disposed on the first electrode EL3. The protecting layer 590 may include an inorganic material such as silicon oxide (SiOx) or silicon nitride (SiNx). In addition, the protecting layer 590 may include an organic insulating material having a relatively low permittivity. The protecting layer 590 may be formed as a multi-layer including the inorganic insulation layer and the organic insulation layer.

The second electrode EL4 is disposed on the protecting layer 590. The second electrode EL4 corresponds to the pixel area. The second electrode EL4 is electrically connected to a common voltage line. The second electrode EL4 may have a slit pattern including a plurality of openings. The second electrode EL4 may include a transparent conductive material such as indium tin oxide (ITO), indium zinc oxide (IZO), etc.

Thus, the array substrate has a color filter on array (COA) structure on which a color filter is formed and a black matrix on array (BOA) structure on which a black matrix is formed.

The opposing substrate includes a second polarizing plate 600 and a second substrate 610.

The second polarizing plate 600 is contacted with a upper surface of the second substrate 610. The second polarizing plate 600 controls polarization of light incident to the liquid crystal layer LC2. The second polarizing plate 600 may include a compensation film having an anisotropic refractive index and including a triacetyl cellulose film, a cyclo olefin polymer or a polymethyl methacrylate, a polarization film including polyvinyl alcohol and a base film supporting the polarization film.

The second substrate 610 is opposite to the first substrate 510.

The second substrate 610 includes a material which has a relatively high transmittance, thermo stability and chemical compatibility. For example, the second substrate 610 may include glass, polyethylene naphthalate, polyethylene terephthalate or polyacryl.

The liquid crystal layer LC2 is disposed between the array substrate and the opposing substrate. The liquid crystal layer LC2 includes liquid crystal molecules having optical anisotropy. The liquid crystal molecules are driven by an electric field generated by voltages applied to the first electrode EL3 and the second electrode EL4 such that an image is displayed by passing or blocking light through the liquid crystal layer LC2.

FIG. 4 is a cross-sectional view illustrating a display panel in accordance with an exemplary embodiment of the inventive concept.

Referring to FIG. 4, the elements in the display panel of FIG. 4 may be substantially the same as the elements in the display panel of FIG. 3, except for the black matrix BM3. Thus, any further descriptions concerning the same elements may be omitted.

A black matrix BM4 is disposed on a protecting layer 550. The black matrix BM4 corresponds to the peripheral area PA and blocks the light. The black matrix BM4 overlaps the data line, the gate line and the thin film transistor TFT.

The black matrix BM4 is formed based on a photosensitive resin composition. The photosensitive resin composition includes about 60% by weight to about 95% by weight of a solvent based on a total weight of the photosensitive resin composition and about 5% by weight to about 40% by weight of a solid based on the total weight of the photosensitive resin composition.

The solid includes a photo polymerization compound, a photo polymerization initiator, an alkali-soluble resin, quantum dots, a dispersing agent and a coloring agent.

The elements in the photosensitive resin composition may be substantially the same as the elements in the photosensitive resin composition of FIG. 3, except for the coloring agent. Thus, any further descriptions concerning the same elements may be omitted.

An amount of the coloring agent is about 0.1% by weight to about 5% by weight based on a total weight of the solid. The coloring agent of the black matrix BM4 may absorb the visible light.

For example, the coloring agent may include a color (Red, Green, or Blue) mixing pigment, an organic color agent or an inorganic coloring agent such as carbon black, etc. Thus, the photosensitive resin composition represents a black color. The coloring agent may include organic materials. For example, the organic materials may include a thermosetting resin or a photo curable resin. For example, the thermosetting resin may include urea resin, melamine resin, phenol resin, etc. For example, the photo curable resin may include polymerizable compounds having a polymerizable functional group, a photo polymerization initiator initiating polymerization of the polymerizable compounds by irradiation, surfactants, antioxidants, etc.

For example, the black matrix BM4 including the quantum dots and the coloring agent emits the infrared ray having a wavelength of about 0.75 μm to about 1 mm and absorbs the visible light having a wavelength of about 380 nm to about 800 nm. Thus, the black matrix BM4 may block energy above a mobility gap of the thin film transistor TFT.

A center luminescence wavelength of the quantum dots is about 900 nm to about 2000 nm.

A conventional black matrix may only block visible light. However, the black matrix BM4 in accordance with an exemplary embodiment of the inventive concept may emit the infrared ray and may absorb the visible light.

According to an exemplary embodiment of the inventive concept, the black matrix BM4 including the quantum dots may emit the infrared ray. Thus, the display panel may be employed in apparatuses which use the infrared ray to improve health and beauty effects of a person, for example.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A photosensitive resin composition comprising:
about 60% by weight to about 95% by weight of a solvent based on a total weight of the photosensitive resin composition; and
about 5% by weight to about 40% by weight of a solid based on the total weight of the photosensitive resin composition,
wherein the solid comprises about 5% by weight to about 90% by weight of quantum dots based on a total weight of the solid, and a center luminescence wavelength of the quantum dots is about 900 nm to about 2000 nm.

2. The photosensitive resin composition of claim 1, wherein the solid comprises:
about 4% by weight to about 70% by weight of a photo polymerization compound based on the total weight of the solid;
about 0.1% by weight to about 20% by weight of a photo polymerization initiator based on the total weight of the solid;
about 5% by weight to about 80% by weight of an alkali-soluble resin based on the total weight of the solid; and
about 0.1% by weight to about 12% by weight of a dispersing agent based on the total weight of the solid.

3. The photosensitive resin composition of claim 1, wherein at least one of the quantum dots comprises a core and a shell surrounding the core.

4. The photosensitive resin composition of claim 3, wherein the core comprises lead selenide (PbSe), lead sulfide (PbS), lead telluride (PbTe) or copper oxide (CuO).

5. The photosensitive resin composition of claim 3, wherein the shell comprises indium phosphide (InP), indium nitride (InN), gallium phosphide (GaP), gallium nitride (GaN), aluminum nitride (AlN), aluminum phosphide (AlP), aluminum arsenide (AlAs), cadmium sulfide (CdS), cadmium selenide (CdSe), cadmium telluride (CdTe), zinc telluride (ZnTe), zinc sulfide (ZnS), zinc selenide (ZnSe), mercury sulfide (HgS), mercury selenide (HgSe) or mercury telluride (HgTe).

6. The photosensitive resin composition of claim 3, wherein a diameter of the core and a diameter of the shell are about 2 nm to about 20 nm, respectively.

7. The photosensitive resin composition of claim 2, wherein the solid further comprises a coloring agent, wherein an amount of the coloring agent is about 0.1% by weight to about 5% by weight based on the total weight of the solid.

8. The photosensitive resin composition of claim 7, wherein the coloring agent comprises carbon black, urea resin, melamine resin, phenol resin or epoxy resin.

9. The photosensitive resin composition of claim 2, wherein the alkali-soluble resin comprises a monocarboxylic acid compound, a dicarboxylic acid compound, a mono methacrylate compound, an alkyl ester compound, a carboxylic ester compound, a vinyl compound, an alicyclic compound having an unsaturated bond with an epoxy group, an epoxy compound or dicarbonyl imide derivatives.

10. The photosensitive resin composition of claim 2, wherein the dispersing agent comprises a polyoxyethylene alkyl ether compound, a polyoxyethylene alkyl phenyl ether compound, a polyethylene glycol diester compound, a sorbitan fatty acid ester compound, a fatty acid-modified polyester compound, a tertiary amine modified polyurethane compound, an alkyl ammonium compound or a polyethyleneimine compound.

11. A display panel comprising:
a first substrate comprising a black matrix comprising quantum dots;
a second substrate opposite to the first substrate; and
a liquid crystal layer disposed between the first substrate and the second substrate,
wherein a center luminescence wavelength of the quantum dots is about 900 nm to about 2000 nm.

12. The display panel of claim 11, wherein the black matrix comprises about 60% by weight to about 95% by weight of a solvent based on a total weight of a photosensitive resin composition and about 5% by weight to about 40% by weight of a solid based on the total weight of the photosensitive resin composition,
wherein the solid comprises:
about 5% by weight to about 20% by weight of the quantum dots based on a total weight of the solid;
about 4% by weight to about 70% by weight of a photo polymerization compound based on the total weight of the solid;
about 0.1% by weight to about 20% by weight of a photo polymerization initiator based on the total weight of the solid;
about 5% by weight to about 80% by weight of an alkali-soluble resin based on the total weight of the solid; and
about 0.1% by weight to about 12% by weight of a dispersing agent based on the total weight of the solid.

13. The display panel of claim 12, wherein at least one of the quantum dots comprises a core and a shell surrounding the core.

14. The display panel of claim 13, wherein the core comprises lead selenide (PbSe), lead sulfide (PbS), lead telluride (PbTe) or copper oxide (CuO).

15. The display panel of claim 13, wherein the shell comprises indium phosphide (InP), indium nitride (InN), gallium phosphide (GaP), gallium nitride (GaN), aluminum nitride (AlN), aluminum phosphide (AlP), aluminum arsenide (AlAs), cadmium sulfide (CdS), cadmium selenide (CdSe), cadmium telluride (CdTe), zinc telluride (ZnTe), zinc sulfide (ZnS), zinc selenide (ZnSe), mercury sulfide (HgS), mercury selenide (HgSe) or mercury telluride (HgTe).

16. The display panel of claim 13, wherein a diameter of the core and a diameter of the shell are about 2 nm to about 20 nm, respectively.

17. The display panel of claim 12, wherein the solid further comprises a coloring agent, wherein an amount of the coloring agent is about 0.1% by weight to about 5% by weight based on the total weight of the solid.

18. The display panel of claim 12, wherein the coloring agent comprises carbon black, urea resin, melamine resin, phenol resin or epoxy resin.

19. The display panel of claim 12, wherein the alkali-soluble resin comprises a monocarboxylic acid compound, a dicarboxylic acid compound, a mono methacrylate compound, an alkyl ester compound, a carboxylic ester compound, a vinyl compound, an alicyclic compound having an unsaturated bond with an epoxy group, an epoxy compound or dicarbonyl imide derivatives.

20. The display panel of claim 12, wherein the dispersing agent comprises a polyoxyethylene alkyl ether compound, a polyoxyethylene alkyl phenyl ether compound, a polyethylene glycol diester compound, a sorbitan fatty acid ester compound, a fatty acid-modified polyester compound, a tertiary amine modified polyurethane compound, an alkyl ammonium compound or a polyethyleneimine compound.
